(19) United States
(12) Patent Application Publication
(10) Pub. No.: US 2024/0375656 A1
(43) Pub. Date: Nov. 14, 2024

(54) SMART REGEN BRAKING INCORPORATING LEARNED DRIVER BRAKING HABITS

(71) Applicants: Hyundai Motor Company, Seoul (KR); Kia Corporation, Seoul (KR)

(72) Inventors: Shihong Fan, Ann Arbor, MI (US); Jason Hoon Lee, Ann Arbor, MI (US); John Harber, Plymouth, MI (US); Justin Holmer, Ann Arbor, MI (US); Heeseong Kim, Ann Arbor, MI (US); Jinho Ha, Seoul (KR); Yue Ming Chen, Ypsilanti, MI (US)

(21) Appl. No.: 18/195,714

(22) Filed: May 10, 2023

(51) Int. Cl. B60W 30/18; B60W 40/04; B60W 40/08

(52) U.S. Cl. CPC B60W 30/18127; B60W 40/04; B60W 40/08; B60W 2420/403; B60W 2420/408; B60W 2540/10; B60W 2540/12; B60W 2554/80

(57) ABSTRACT

Systems and methods for performing smart regenerative braking incorporating learned driver braking habits are provided. The method may comprise receiving, from one or more sensors coupled to a vehicle, one or more input signals. The vehicle may comprise a computing device. The method may comprise, using the computing device, implementing an advanced driver-assistance system and map info processing model to determine whether, within an environment of the vehicle, there is at least one of a traffic sign, a traffic light, and a preceding vehicle between the vehicle and the traffic sign or traffic light, implementing a learning model configured to use one or more braking habits of a driver of the vehicle to tune a calibration factor, and implementing a desired braking distance model to determine, using the calibration factor, a desired deceleration and convert the desired deceleration to a desired torque for a motor.

### BACKGROUND

### 1. Technical Field

Embodiments of the present disclosure relate to systems and methods for performing smart regenerative braking incorporating learned driver braking habits.

### 2. Background

A main issue pertaining to environmentally-friendly vehicle (e.g., hybrid vehicles, electric vehicles, fuel cell vehicles, etc.) performance is battery life maximization. The shorter the batter life of an environmentally-friendly vehicle, the more frequent the environmentally-friendly vehicle will require recharging.

Generally, when braking a vehicle, the process of decreasing vehicle velocity wastes energy. This energy is typically in the form of heat particularly heat. In regenerative braking, a portion of this wasted energy may be recovered, powering a motor to recharge the fuel cells.

Currently, in order to maximize the battery life of environmentally-friendly vehicles, a regenerative brake mode has been introduced to apply regenerative braking when a gas pedal of the environmentally-friendly vehicle is not used. However, a standard, active regenerative brave mode decreases the smoothness of the ride of the vehicle, decreases the coasting ability of the vehicle, and may affect the feel and responsiveness of the vehicle's brakes. These attributes of standard regenerative braking generally decrease user satisfaction of the driving experience.

### SUMMARY

According to an object of the present disclosure, a method for performing smart regenerative braking incorporating learned driver braking habits is provided. The method may comprise receiving, from one or more sensors coupled to a vehicle, one or more input signals. The vehicle may comprise a computing device comprising a processor and a memory. The method may comprise, using the computing device, implementing an advanced driver-assistance system (ADAS) and map info processing model to determine whether, within an environment of the vehicle, there is at least one of a traffic sign, a traffic light, and a preceding vehicle between the vehicle and the traffic sign or traffic light, implementing a learning model configured to use one or more braking habits of a driver of the vehicle to tune a calibration factor, and implementing a desired braking distance model to determine, using the calibration factor, a desired deceleration and convert the desired deceleration to a desired torque for a motor.

According to an exemplary embodiment, the one or more sensors may comprise at least one of: a LiDAR sensor; a RADAR sensor; a camera; and a position determining sensor.

According to an exemplary embodiment, the implementing the ADAS and map info processing model may comprise, using the computing device: when there is a traffic sign within the environment of the vehicle, determining whether the traffic sign is a stop sign; or when there is a traffic light within the environment of the vehicle, determining whether the traffic light is a red light.

According to an exemplary embodiment, the implementing the ADAS and map info processing model may comprise, using the computing device: implementing a coasting mode of the vehicle when the traffic sign is not a stop sign and when the traffic light is not a red light.

According to an exemplary embodiment, the vehicle may further comprise a brake pedal, and the implementing the learning model may comprise, using the computing device, receiving one or more inputs indicating whether a brake pedal of the vehicle is pressed or is being pressed.

According to an exemplary embodiment, the implementing the desired braking distance model may further comprise, using the computing device: generating and outputting an output signal configured to cause the vehicle to perform one or more actions, and performing the one or more actions.

According to an exemplary embodiment, the one or more actions may comprise at least one of: braking, accelerating; changing direction; maintaining a distance between vehicle and one or more objects or obstacles; adjusting a position of a brake pedal; and adjusting a position of an acceleration pedal.

According to an object of the present disclosure, a vehicle is provided. The vehicle may comprise one or more sensors and a computing device, comprising a processor and a memory. The computing device may be configured to receive, from the one or more sensors, one or more input signals, implement an ADAS and map info processing model to determine whether, within an environment of the vehicle, there is at least one of a traffic sign, a traffic light, and a preceding vehicle between the vehicle and the traffic sign or traffic light, implement a learning model configured to use one or more braking habits of a driver of the vehicle to tune a calibration factor. and implement a desired braking distance model to determine, using the calibration factor, a desired deceleration and convert the desired deceleration to a desired torque for a motor.

According to an exemplary embodiment, the one or more sensors may comprise at least one of a LIDAR sensor, a RADAR sensor, a camera, and a position determining sensor.

According to an exemplary embodiment, when implementing the ADAS and map info processing model, the computing device may be configured to, when there is a traffic sign within the environment of the vehicle, determine whether the traffic sign is a stop sign, or, when there is a traffic light within the environment of the vehicle, determine whether the traffic light is a red light.

According to an exemplary embodiment, when implementing the ADAS and map info processing model, the computing device may be configured to implement a coasting mode of the vehicle when the traffic sign is not a stop sign and when the traffic light is not a red light.

According to an exemplary embodiment, the vehicle may further comprise a brake pedal and, when implementing the learning model, the computing device may be configured to receive one or more inputs indicating whether a brake pedal of the vehicle is pressed or is being pressed.

According to an exemplary embodiment, when implementing the desired braking distance model, the computing device may be configured to generate and output an output signal configured to cause the vehicle to perform one or more actions and cause the vehicle to perform the one or more actions.

According to an exemplary embodiment, the one or more actions may comprise at least one of: braking, accelerating; changing direction; maintaining a distance between vehicle and one or more objects or obstacles; adjusting a position of a brake pedal; and adjusting a position of an acceleration pedal.

According to an object of the present disclosure, a system for performing smart regenerative braking incorporating learned driver braking habits is provided. The system may comprise, a vehicle comprising one or more sensors, and a computing device, comprising a processor and a memory. The computing device may be configured to store programming instructions that, when executed by the processor, cause the processor to: receive, from the one or more sensors, one or more input signals, implement an ADAS and map info processing model to determine whether, within an environment of the vehicle, there is at least one of a traffic sign, a traffic light, and a preceding vehicle between the vehicle and the traffic sign or traffic light, implement a learning model configured to use one or more braking habits of a driver of the vehicle to tune a calibration factor, and implement a desired braking distance model to determine, using the calibration factor, a desired deceleration and convert the desired deceleration to a desired torque for a motor.

According to an exemplary embodiment, when implementing the ADAS and map info processing model, the programming instructions, when executed by the processor, may be configured to, when there is a traffic sign within the environment of the vehicle, determine whether the traffic sign is a stop sign, or, when there is a traffic light within the environment of the vehicle, determine whether the traffic light is a red light.

According to an exemplary embodiment, when implementing the ADAS and map info processing model, the programming instructions, when executed by the processor, may be configured to implement a coasting mode of the vehicle when the traffic sign is not a stop sign, and when the traffic light is not a red light.

According to an exemplary embodiment, the vehicle may further comprise a brake pedal, and, when implementing the learning model, the programming instructions, when executed by the processor, may be configured to receive one or more inputs indicating whether a brake pedal of the vehicle is pressed or is being pressed.

According to an exemplary embodiment, when implementing the desired braking distance model, the programming instructions, when executed by the processor, may be configured to generate and output an output signal configured to cause the vehicle to perform one or more actions, and cause the vehicle to perform the one or more actions.

According to an exemplary embodiment, the one or more actions may comprise at least one of: braking; accelerating; changing direction; maintaining a distance between vehicle and one or more objects or obstacles; adjusting a position of a brake pedal; and adjusting a position of an acceleration pedal.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a vehicle configured to perform smart regenerative braking incorporating learned driver braking habits, according to an exemplary embodiment of the present disclosure.

FIG. 2 illustrates a flowchart of a method for performing smart regenerative braking incorporating learned driver braking habits, according to an exemplary embodiment of the present disclosure

FIG. 3 illustrates a flowchart of a method for implementing an advanced driver-assistance system (ADAS) and map info processing model, according to an exemplary embodiment of the present disclosure.

FIG. 4 illustrates a flowchart of a method for implementing a desired braking distance mode, according to an exemplary embodiment of the present disclosure.

FIG. 5 illustrates example elements of a computing device, according to an exemplary embodiment of the present disclosure.

FIG. 6 illustrates an example architecture of a vehicle, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3% 7%, 1%, 0,5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only, memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also; the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Embodiments described herein provide systems and methods for performing smart regenerative braking incorporating learned driver braking habits.

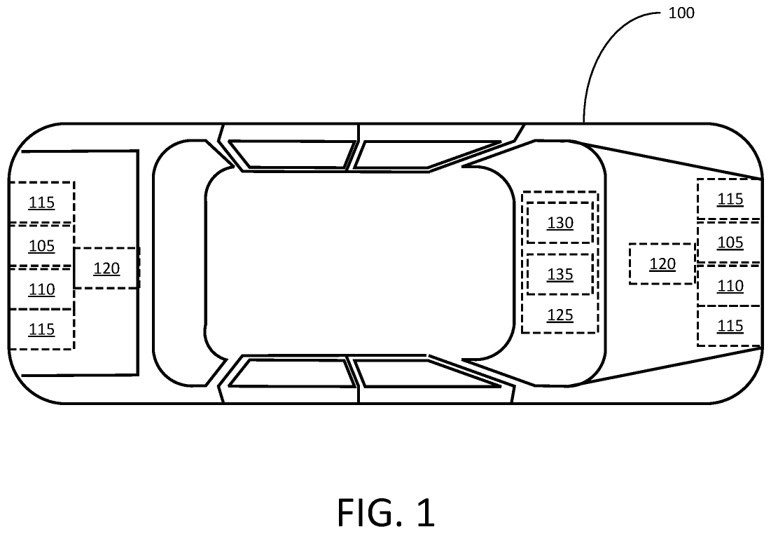

Referring now to FIG. 1, a vehicle 100 configured to perform smart regenerative braking incorporating learned driver braking habits is illustratively depicted, in accordance with an exemplary embodiment of the present disclosure.

According to an exemplary embodiment, the vehicle 100 may comprise one or more sensors such as, for example, one or more LiDAR sensors 105, one or more radio detection and ranging (RADAR) sensors 110, one or more cameras 115, and/or one or more position determining sensors 120 (e.g., one or more Global Positioning System devices), among other suitable sensors. According to an exemplary embodiment, the one or more sensors may be in electronic communication with one or more computing devices 125. The one or more computing devices 125 may be separate from the one or more sensors and/or may be incorporated into the one or more sensors.

According to an exemplary embodiment, the computing device 125 may comprise a processor 130 and/or a memory 135. The memory 135 may be configured to store programming instructions that, when executed by the processor 130, may be configured to cause the processor 130 to perform one or more tasks such as, e.g., receiving and analyzing one or more vehicle and/or sensor inputs, implementing an ADAS and map info processing model, implementing a desired braking distance model, implementing a learning model, determining one or more vehicle actions, and/or performing one or more vehicle actions, among other functions.

According to an exemplary embodiment, the memory 135 may be configured to store a smart braking control algorithm which may be executed by the processor 130. The smart braking control algorithm may comprise (1) an advanced driver-assistance system (ADAS) and map info processing model, (2) a desired braking distance model, (3) a learning model, and (4) a module to convert a desired deceleration to a desired torque for a motor.

According to an exemplary embodiment, the smart braking control algorithm, when executed by the processor 130, may be configured to cause the vehicle 100 to perform one or more vehicle actions such as, e.g., braking the vehicle based on one or more obstacles within the environment of the vehicle 100 (e.g., traffic, pedestrians, roadblocks, etc.). According to an exemplary embodiment, when a driver presses the vehicle 100 brake, the memory 135 and/or processor 130 may be configured to override a command from the smart braking control algorithm to apply the vehicle 100 brake. According to an exemplary embodiment, such a habit may be stored, in the memory 135, in a learning model to mimic better braking of the vehicle 100 in the future.

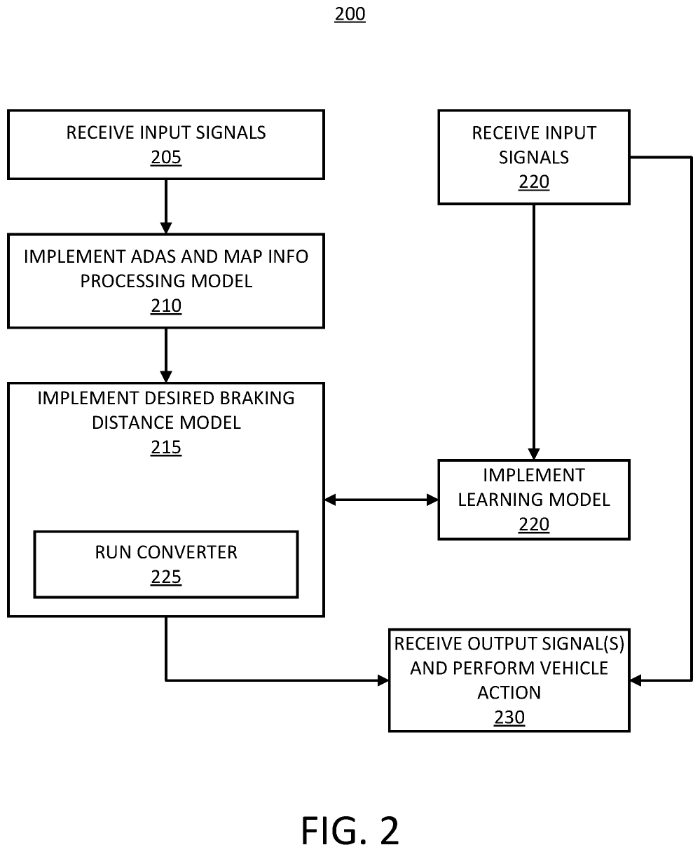

Referring now to FIG. 2, a method 200 for performing smart regenerative braking incorporating learned driver braking habits, in accordance with an exemplary embodiment of the present disclosure.

At 205, input signals may be received from the one or more sensors (e.g., the one or more LiDAR sensors 105, the one or more RADAR sensors 110, the one or more cameras 115, and/or the one or more position determining sensors 120, among other suitable sensors).

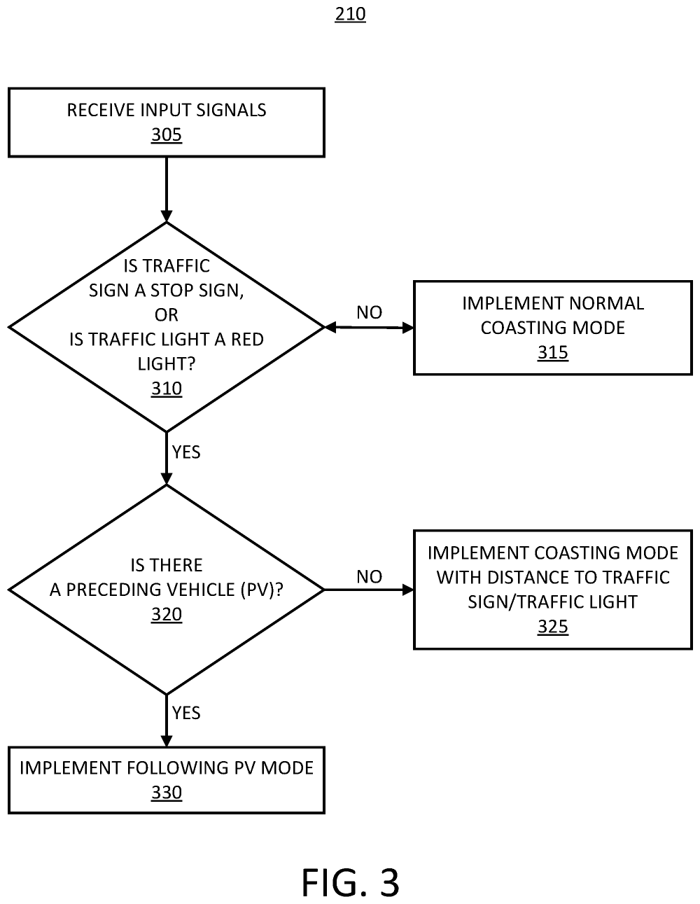

At 210, the ADAS and map info processing model is used/implemented to provide environment information (e.g., relative distance, relative velocity, distance to traffic light, traffic light state, distance to traffic sign, road slop, etc.) to core logic. The method 210 for implementing the ADAS and map info processing model is shown, in more detail, in FIG. 3.

As shown in FIG. 3, at 305, input signals may be received from the one or more sensors pertaining to one or more traffic signs and/or one or more traffic lights. At 310, traffic sign and/or traffic light recognition mode may be performed in order to determine whether a traffic sign and/or traffic signal has been detected and whether a detected traffic sign is recognized as a stop sign and/or whether a detected traffic light is recognized as a red light. It is noted, however, that, in sonic exemplary embodiments traffic signs and/or other traffic lights may be incorporated, while maintaining the spirit and functionality of the present disclosure.

When neither a detected traffic sign is recognized as a stop sign nor a detected traffic light is recognized as a red light, then, at 315, a coasting mode may be implemented. According to an exemplary embodiment, in a coasting mode, the smart braking control algorithm may be configured to use vehicle 100 information and road information to calculate a coasting acceleration.

When a detected traffic sign is recognized as a stop sign and/or a detected traffic light is recognized as a red light, then, at 320, it is determined whether there is a preceding vehicle (PY) between the traffic sign and/or the traffic light.

When there is not a PV between the traffic sign and/or the traffic light, then, at 325, a coasting mode may be implemented with a distance to the traffic sign and/or traffic light.

When there is a PV between the traffic sign and/or the traffic light, then, at 330, a following PV mode may be implemented. According to an exemplary embodiment, in the following PV mode, the smart braking control algorithm may be configured to use a relative distance and a relative velocity to calculate a desired braking distance. According to an exemplary embodiment, the desired braking distance may be calculated using a desired braking distance model. According to an exemplary embodiment, the desired braking distance model may incorporate a correction factor.

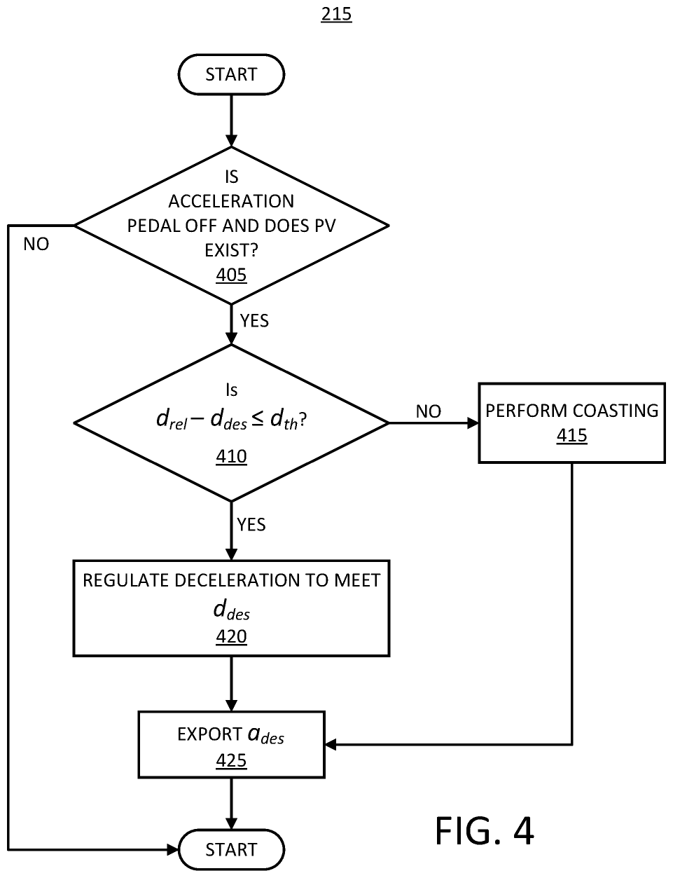

Referring back to FIG. 2, at 215, the desired braking distance model may be implemented. The method 215 for implementing the desired braking distance model is shown, in more detail, in FIG. 4.

As shown in FIG. 4, at 405, the processor 130 may be configured to determine whether an acceleration pedal of the vehicle 100 (e.g., an ego vehicle) is in an off position and whether a PV exists between the traffic signal and/or traffic light.

According to an exemplary embodiment, when the acceleration pedal of the vehicle 100 is not in an off position and no PV exists between the traffic signal and/or the traffic light, then the method for implementing the desired braking distance model may end.

According to an exemplary embodiment, when the acceleration pedal of the vehicle 100 is in the off position and a PV exists between the traffic signal and/or traffic light, then, at 410 it is determined whether a measured relative distance, dᵣₑₗ, minus a desired relative distance, d_{des}, is less than or equal to a threshold distance, dₜₕ. According to an exemplary embodiment, the relative distance, dᵣₑₗ, may be equal to a position at an end of a PV, x_{PV}, minus a position at a front of the ego vehicle 100, x_{ego}, as shown in Equation 1.

$${d}_{rel} = {x}_{PV} - {x}_{ego} \qquad Equation 1$$

According to an exemplary embodiment, when the relative distance, dᵣₑₗ, minus the desired distance, d_{des}, is not less than or equal to the threshold distance, dₜₕ, then, at 415, coasting is performed.

According to an exemplary embodiment, during coasting, a coasting acceleration, α_{coasting}, may be calculated, according to Equation 2.

$${a}_{coasting} = \frac{{f}_{0} + {f}_{1} {v}_{v} + {f}_{2} {v}_{v}^{2}}{{m}_{v}} \qquad Equation 2$$

According to an exemplary embodiment, f₀, f₁, and f₂ are driving resistances, Vᵥ is a velocity of the vehicle 100, and mᵥ is a mass of the vehicle 100.

According to an exemplary embodiment, the coasting acceleration, α_{coasting}, is a desired acceleration, α_{des}, which, at 425, may be exported.

According to an exemplary embodiment, when the relative distance, dᵣₑₗ, minus the desired distance, d_{des}, is less than or equal to the threshold distance, dₜₕ, then, at 420, deceleration may be regulated to meet the desired distance, d_{des}.

According to an exemplary embodiment, regulating the deceleration may comprise determining the relative distance, dᵣₑₗ, and the desired distance, d_{des}, based on Equation 1, Equation 3, Equation 4, and Equation 5.

$$Δ v = {v}_{ego} + {v}_{PV} \qquad Equation 3$$

$${d}_{des} = {d}_{s} + τ {v}_{ego} + b Δ {v}^{2} \qquad Equation 4$$

$${c}_{f} = \frac{{d}_{rel}}{{d}_{des}} \qquad Equation 5$$

According to an exemplary embodiment, Δv is a relative velocity, v_{ego} is the velocity of the ego vehicle, v_{PV} is the velocity of the preceding vehicle, dₛ is the minimum stopping distance between the preceding vehicle and ego vehicle, ι is a time head way between the preceding vehicle and ego vehicle, b is a calibration factor, and c_{f} is a calibration factor. According to an exemplary embodiment, Δv is defined as positive when the ego vehicle 100 is approaching the PV, According to an exemplary embodiment, road slope may be factored in as a factor in determining the desired distance, d_{des}.

According to an exemplary embodiment, a converter may be run, at 225 of FIG. 2, to convert the d_{des} to generate a desired acceleration, α_{des} and a desired torque of a motor which, at 425, may be exported. According to an exemplary embodiment, the converter may be a proportional-integral (PI) and/or proportional-integral-derivative (PM) controller. It is noted, however, that other suitable controllers and/or converters may be implemented, while maintaining the spirit and functionality of the present disclosure.

According to an exemplary embodiment, implementing the desired braking distance model, at 215, results in the generation and output of an output signal configured to cause the vehicle 100 to perform one or more actions (e.g., braking, emergency braking, hold braking, accelerating, changing direction, maintaining a distance between vehicle 100 and one or more objects/obstacles, etc.). According to an exemplary embodiment, the computing device 130, at 230, may receive the output signal(s), causing the vehicle 100 to implement/perform the one or more vehicle actions designated in the output signal(s). According to an exemplary embodiment, performing the one or more vehicle actions may comprise adjusting the position of the brake pedal and/or the acceleration pedal.

According to an exemplary embodiment, the desired braking distance model may receive input from a learning model which, in turn, may receive input from one or more input signals pertaining to driver brake input.

Referring back to FIG. 1, the computing device 130 may receive one or more input signals pertaining to driver brake input (indicating whether a brake pedal of the vehicle 100 is pressed and/or is being pressed). According to an exemplary embodiment, the input signals may be incorporated into a learning model which may be implemented, at 220.

According to an exemplary embodiment, the learning model may comprise a self-learning model which may be configured to use a driver's braking habit(s) to tune the calibration factor, c_{f}, of the smart braking logic. In this way, the smart braking control algorithm may be configured to perform a same braking performance as the driver.

According to an exemplary embodiment, the learning model may comprise a smart learning model that may be configured to enable the smart braking control algorithm to self-tune the calibration factor, c_{f}, to produce a better and smoother braking behaver by learning from the driver's braking habit(s).

According to an exemplary embodiment, the smart braking control algorithm may be configured to implement a model predictive control method configured to control in the development path. The flow chart is shown on the right.

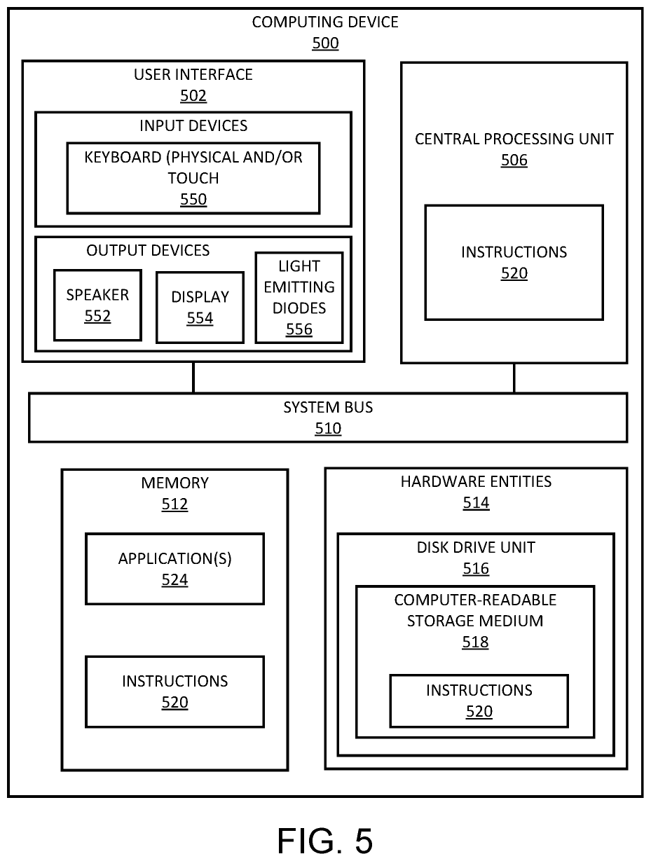

Referring now to FIG. 5, an illustration of an example architecture for a computing device 500 is provided. According to an exemplary embodiment, one or more functions of the present disclosure may be implemented by a computing device such as, e.g., computing device 500 or a computing device similar to computing device 500. The computing device 130 of FIG. 1 may be the same as or similar to computing device 500. As such, the discussion of computing device 500 is sufficient for understanding the computing device 130 of FIG. 1.

The hardware architecture of FIG. 5 represents one example implementation of a representative computing device configured to perform one or more methods and means for performing smart regenerative braking incorporating learned driver braking habits, as described herein. As such, the computing device 500 of FIG. 5 may be configured to implement at least a portion of the method(s) described herein (e.g., method 200 of FIG. 2, method 210 of FIG. 3, and method 215 of FIG. 4) and/or implement at least a portion of the functions of the system(s) described herein (e.g., vehicle 100 of FIG. 1).

Some or all components of the computing device 500 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 5, the computing device 500 may comprise a user interface 502, a Central Processing Unit (“CPU”) 506, a system bus 510, a memory 512 connected to and accessible by other portions of computing device 500 through system bus 510, and hardware entities 514 connected to system bus 510. The user interface may comprise input devices and output devices, which may be configured to facilitate user-software interactions for controlling operations of the computing device 500. The input devices may comprise, but are not limited to, a physical and/or touch keyboard 540. The input devices may be connected to the computing device 500 via a wired or wireless connection (e.g., a Bluetooth® connection). The output devices may comprise, but are not limited to, a speaker 542, a display 544, and/or light emitting diodes 546.

At least some of the hardware entities 514 may be configured to perform actions involving access to and use of memory 512, which may be a Random Access Memory (RAM), a disk driver and/or a Compact Disc Read Only Memory (CD-ROM), among other suitable memory types. Hardware entities 514 may comprise a disk drive unit 516 comprising a computer-readable storage medium 518 on which may be stored one or more sets of instructions 520 (e.g., programming instructions such as, but not limited to, software code) configured to implement one or more of the methodologies, procedures, or functions described herein. The instructions 520 may also reside, completely or at least partially, within the memory 512 and/or within the CPU 506 during execution thereof by the computing device 500.

The memory 512 and the CPU 506 may also constitute machine-readable media. The term “machine-readable media”, as used here, refers to a single medium or multiple media (e.g., a centralized or distributed database, and/or associated caches and servers) that store the one or more sets of instructions 520. The term “machine-readable media”, as used here, also refers to any medium that is capable of storing, encoding or carrying a set of instructions 520 for execution by the computing device 500 and that cause the computing device 500 to perform any one or more of the methodologies of the present disclosure.

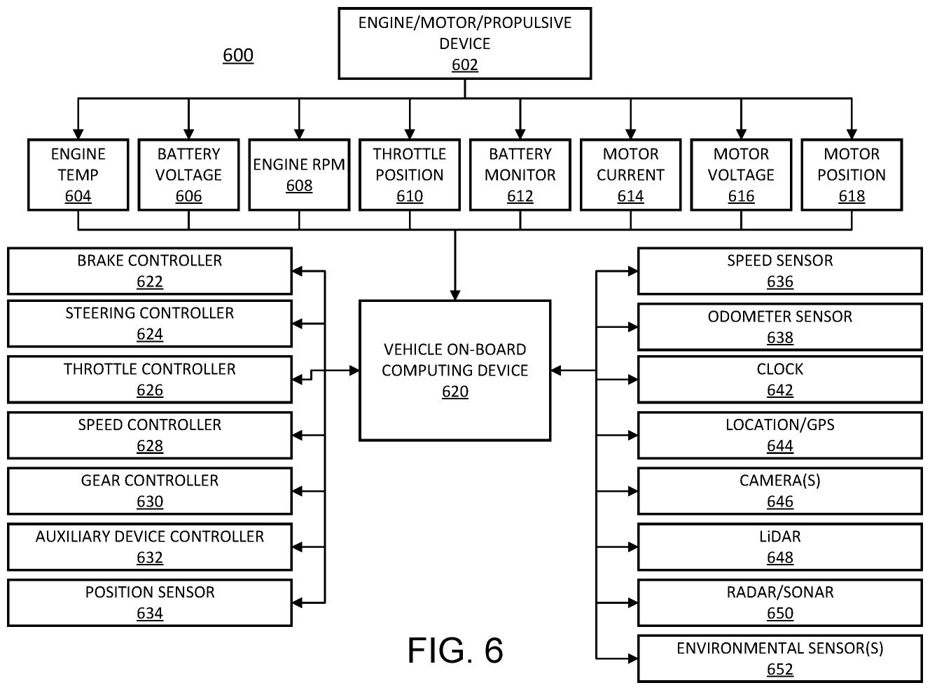

Referring now to FIG. 6, an example vehicle system architecture 600 for a vehicle is provided, in accordance with an exemplary embodiment of the present disclosure.

Vehicle 100 may be a vehicle having the same or similar system architecture as that shown in FIG. 6. Thus, the following discussion of vehicle system architecture 600 is sufficient for understanding one or more components of the vehicle 100 of FIG. 1.

As shown in FIG. 6, the vehicle system architecture 600 may comprise an engine, motor or propulsive device (e.g., a thruster) 602 and various sensors 604-618 for measuring various parameters of the vehicle system architecture 600. In gas-powered or hybrid vehicles having a fuel-powered engine, the sensors 604-618 may comprise, for example, an engine temperature sensor 604, a battery voltage sensor 606, an engine Rotations Per Minute (RPM) sensor 608, and/or a throttle position sensor 610. If the vehicle is an electric or hybrid vehicle, then the vehicle may comprise an electric motor, and accordingly may comprise sensors such as a battery monitoring system 612 (to measure current, voltage and/or temperature of the battery), motor current 614 and voltage 616 sensors, and motor position sensors such as resolvers and encoders 618.

Operational parameter sensors that are common to both types of vehicles may comprise, for example: a position sensor 634 such as an accelerometer, gyroscope and/or inertial measurement unit; a speed sensor 636; and/or an odometer sensor 638. The vehicle system architecture 600 also may comprise a clock 642 that the system uses to determine vehicle time and/or date during operation. The clock 642 may be encoded into the vehicle on-board computing device 620, it may be a separate device, or multiple clocks may be available.

The vehicle system architecture 600 also may comprise various sensors that operate to gather information about the environment in which the vehicle is traveling. These sensors may comprise, for example: a location sensor 644 (for example, a Global Positioning System (GPS) device); object detection sensors such as one or more cameras 646; a LiDAR sensor system 648; and/or a RADAR and/or a sonar system 650. The sensors also may comprise environmental sensors 652 such as, e.g., a humidity sensor, a precipitation sensor, a light sensor, and/or ambient temperature sensor. The object detection sensors may be configured to enable the vehicle system architecture 600 to detect objects that are within a given distance range of the vehicle in any direction, while the environmental sensors 652 may be configured to collect data about environmental conditions within the vehicle's area of travel. According to an exemplary embodiment, the vehicle system architecture 600 may comprise one or more lights 654 (e.g., headlights, flood lights, flashlights, etc.).

During operations, information may be communicated from the sensors to an on-board computing device 620 (e.g., computing device 130 of FIG. 1 and computing device 500 of FIG. 5). The on-board computing device 620 may be configured to analyze the data captured by the sensors and/or data received from data providers and may be configured to optionally control operations of the vehicle system architecture 600 based on results of the analysis. For example, the on-board computing device 620 may be configured to control: braking via a brake controller 622; direction via a steering controller 624; speed and acceleration via a throttle controller 626 (in a gas-powered vehicle) or a motor speed controller 628 (such as a current level controller in an electric vehicle); a differential gear controller 630 (in vehicles with transmissions); and/or other controllers. The brake controller 622 may comprise a pedal effort sensor, pedal effort sensor, and/or simulator temperature sensor, as described herein.

Geographic location information may be communicated from the location sensor 644 to the on-board computing device 620, which may then access a map of the environment that corresponds to the location information to determine known fixed features of the environment such as streets, buildings, stop signs and/or stop/go signals. Captured images from the cameras 646 and/or object detection information captured from sensors such as LiDAR 648 may be communicated from those sensors to the on-board computing device 620. The object detection information and/or captured images may be processed by the on-board computing device 620 to detect objects in proximity to the vehicle. Any known or to be known technique for making an object detection based on sensor data and/or captured images may be used in the embodiments disclosed in this document.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A method for performing smart regenerative braking incorporating learned driver braking habits, comprising:
receiving, from one or more sensors coupled to a vehicle, one or more input signals,
wherein the vehicle comprises a computing device, comprising a processor and a memory; and
using the computing device:
implementing an advanced driver-assistance system (ADAS) and map info processing model to determine whether, within an environment of the vehicle, there is at least one of:
a traffic sign;
a traffic light; and
a preceding vehicle between the vehicle and the traffic sign or traffic light;
implementing a learning model configured to use one or more braking habits of a driver of the vehicle to tune a calibration factor; and
implementing a desired braking distance model to:
determine, using the calibration factor, a desired deceleration; and
convert the desired deceleration to a desired torque for a motor.

2. The method of claim 1, wherein the one or more sensors comprise at least one of:
a LiDAR sensor;
a RADAR sensor;
a camera; and
a position determining sensor.

3. The method of claim 1, wherein the implementing the ADAS and map info processing model comprises, using the computing device:
when there is a traffic sign within the environment of the vehicle, determining whether the traffic sign is a stop sign; or
when there is a traffic light within the environment of the vehicle, determining whether the traffic light is a red light.

4. The method of claim 3, wherein the implementing the ADAS and map info processing model comprises, using the computing device:
implementing a coasting mode of the vehicle:
when the traffic sign is not a stop sign; and
when the traffic light is not a red light.

5. The method of claim 1, wherein:
the vehicle further comprises a brake pedal, and
the implementing the learning model comprises, using the computing device, receiving one or more inputs indicating whether a brake pedal of the vehicle is pressed or is being pressed.

6. The method of claim 1, wherein the implementing the desired braking distance model further comprises, using the computing device:
generating and outputting an output signal configured to cause the vehicle to perform one or more actions; and
performing the one or more actions.

7. The method of claim 6, wherein the one or more actions comprises at least one of:
braking;
accelerating;
changing direction;
maintaining a distance between vehicle and one or more objects or obstacles;
adjusting a position of a brake pedal; and
adjusting a position of an acceleration pedal.

8. A vehicle, comprising:
one or more sensors; and
a computing device, comprising a processor and a memory,
wherein the computing device is configured to:
receive, from the one or more sensors, one or more input signals;
implement an advanced driver-assistance system (ADAS) and map info processing model to determine whether, within an environment of the vehicle, there is at least one of:
a traffic sign;
a traffic light; and
a preceding vehicle between the vehicle and the traffic sign or traffic light;
implement a learning model configured to use one or more braking habits of a driver of the vehicle to tune a calibration factor; and
implement a desired braking distance model to:
determine, using the calibration factor, a desired deceleration; and
convert the desired deceleration to a desired torque for a motor.

9. The vehicle of claim 8, wherein the one or more sensors comprise at least one of:
a LiDAR sensor;
a RADAR sensor;
a camera; and
a position determining sensor.

10. The vehicle of claim 8, wherein, when implementing the ADAS and map info processing model, the computing device is configured to:
when there is a traffic sign within the environment of the vehicle, determine whether the traffic sign is a stop sign; or
when there is a traffic light within the environment of the vehicle, determine whether the traffic light is a red light.

11. The vehicle of claim 10, wherein, when implementing the ADAS and map info processing model, the computing device is configured to:
implement a coasting mode of the vehicle:
when the traffic sign is not a stop sign; and
when the traffic light is not a red light.

12. The vehicle of claim 8, further comprising a brake pedal,
wherein, when implementing the learning model, the computing device is configured to receive one or more inputs indicating whether a brake pedal of the vehicle is pressed or is being pressed.

13. The vehicle of claim 8, wherein, when implementing the desired braking distance model, the computing device is configured to:
generate and output an output signal configured to cause the vehicle to perform one or more actions; and
cause the vehicle to perform the one or more actions.

14. The vehicle of claim 13, wherein the one or more actions comprises at least one of:
braking;
accelerating;
changing direction;
maintaining a distance between vehicle and one or more objects or obstacles;
adjusting a position of a brake pedal; and
adjusting a position of an acceleration pedal.

15. A system for performing smart regenerative braking incorporating learned driver braking habits, comprising:
a vehicle comprising one or more sensors; and
a computing device, comprising a processor and a memory, configured to store programming instructions that, when executed by the processor, cause the processor to:
receive, from the one or more sensors, one or more input signals;
implement an advanced driver-assistance system (ADAS) and map info processing model to determine whether, within an environment of the vehicle, there is at least one of:
a traffic sign;
a traffic light; and
a preceding vehicle between the vehicle and the traffic sign or traffic light;
implement a learning model configured to use one or more braking habits of a driver of the vehicle to tune a calibration factor; and
implement a desired braking distance model to:
determine, using the calibration factor, a desired deceleration; and
convert the desired deceleration to a desired torque for a motor.

16. The system of claim 15, wherein, when implementing the ADAS and map info processing model, the programming instructions, when executed by the processor, are configured to:
when there is a traffic sign within the environment of the vehicle, determine whether the traffic sign is a stop sign; or
when there is a traffic light within the environment of the vehicle, determine whether the traffic light is a red light.

17. The system of claim 16, wherein, when implementing the ADAS and map info processing model, the programming instructions, when executed by the processor, are configured to:
implement a coasting mode of the vehicle:
when the traffic sign is not a stop sign; and
when the traffic light is not a red light.

18. The system of claim 15, wherein:
the vehicle further comprises a brake pedal, and
when implementing the learning model, the programming instructions, when executed by the processor, are configured to receive one or more inputs indicating whether a brake pedal of the vehicle is pressed or is being pressed.

19. The system of claim 15, wherein, when implementing the desired braking distance model, the programming instructions, when executed by the processor, are configured to:
generate and output an output signal configured to cause the vehicle to perform one or more actions; and
cause the vehicle to perform the one or more actions.

20. The system of claim 19, wherein the one or more actions comprises at least one of:
braking;
accelerating;
changing direction;
maintaining a distance between vehicle and one or more objects or obstacles;
adjusting a position of a brake pedal; and
adjusting a position of an acceleration pedal.
